(19) United States
(12) Patent Application Publication
(10) Pub. No.: US 2014/0201006 A1
(43) Pub. Date: Jul. 17, 2014

(54) System And Method For Creating and Distributing Electronic Advertisements

(71) Applicant: Gary W. SIPPEL, Mukilteo, WA (US)

(72) Inventor: Gary W. SIPPEL, Mukilteo, WA (US)

(21) Appl. No.: 14/062,013

(22) Filed: Oct. 24, 2013

Related U.S. Application Data
(60) Provisional application No. 61/752,293, filed on Jan. 14, 2013.

(51) Int. Cl. G06Q 30/02

(52) U.S. Cl. CPC G06Q 30/0267; G06Q 30/0276
USPC 705/14.64

(57) ABSTRACT

A system and method for creating and distributing electronic advertisements, wherein a business can create a user account in order to create and manage advertisements stored in an advertisement repository. A quick response code is created for the user account of each business, with the quick response code having an encoded value. Consumers can scan the quick response code using a portable computing device. Once the quick response code a code reader software of the portable computing device determines a decoded value. The decoded value is then matched to the encoded value in order to retrieve at least one advertisement from the advertisement repository. The at least one advertisement is then formatted according to operating specifications of the portable computing device and a display arrangement is determined for the at least one advertisement. The at least one advertisement is then transmitted to the portable computing device in the display arrangement.

The current application claims a priority to the U.S. Provisional Patent application Ser. No. 61/752,293 filed on Jan. 14, 2013.

### FIELD OF THE INVENTION

The present invention relates generally to a system and method of distributing advertisements. More specifically, businesses can create and manage advertisements from a central source. Furthermore, the user account of each business is provided with a unique quick response code to distribute to consumers.

### BACKGROUND OF THE INVENTION

Businesses are always looking to find new ways to market their products to consumers. With the growth of current technologies, more and more advertisements are being accessed and distributed electronically. Electronic marketing provides a valuable platform for many businesses as it can be used to reach a much more widespread consumer audience. While this is especially beneficial to larger companies that can afford to hire a large marketing department it is not always conducive to smaller business as they lack the resources to hire such employees. As a result much marketing done by smaller businesses is often performed by the owner or individuals with other responsibilities within the business. These individuals do not always have the creative or technological skills and/or time to create and manage such electronic adds.

Therefore it is the object of the present invention to provide a system and method to create and manage electronically distributed advertisements. Users can subscribe to a host website that allows them to create, upload and manage advertisements. Advertisements are uploaded and removed in real-time. Each company with a user account is provided with a quick response code that is linked to the user account. When a consumer scans the quick response code on a sign, in a newspaper, on a business card, etc., advertisements for the associated user account are retrieved and displayed to the consumer. The order in which advertisements are displayed to the consumer is determined by a set of priority criteria defined by the host website and subscribed user.

### BRIEF DESCRIPTION OF THE DRAWINGS

FIG. 1a is a flowchart depicting the overall process of creating a new advertisement and displaying advertisements on a portable computing device.

FIG. 1b is a continuation of the flowchart depicted in FIG. 1a.

FIG. 2 is a flowchart expanding on step D of the method shown in FIG. 1a and FIG. 1b.

FIG. 3 is a flowchart expanding on step D of the method shown in FIG. 1a and FIG. 1b.

FIG. 4 is a flowchart expanding on step G of the method shown in FIG. 1a and FIG. 1b.

FIG. 5 is a flowchart expanding on step J of the method shown in FIG. 1a and FIG. 1b.

FIG. 6 is a flowchart expanding on step J of the method shown in FIG. 1a and FIG. 1b.

FIG. 7 is a flowchart expanding on step J of the method shown in FIG. 1a and FIG. 1b.

FIG. 8 is a flowchart expanding on step J of the method shown in FIG. 1a and FIG. 1b.

FIG. 9 is a flowchart expanding on step J of the method shown in FIG. 1a and FIG. 1b.

FIG. 10 is a flowchart expanding on step H of the method shown in FIG. 1a and FIG. 1b.

FIG. 11 is a flowchart expanding on step H of the method shown in FIG. 1a and FIG. 1b.

FIG. 12 is a diagram depicting a portable computing device scanning a quick response code in order to obtain the encoded value of the quick response code.

FIG. 13 is a diagram depicting the portable computing device of FIG. 12 having retrieved the advertisements linked to the quick response code.

FIG. 14 is a diagram depicting the communications between the portable computing device and the at least one server.

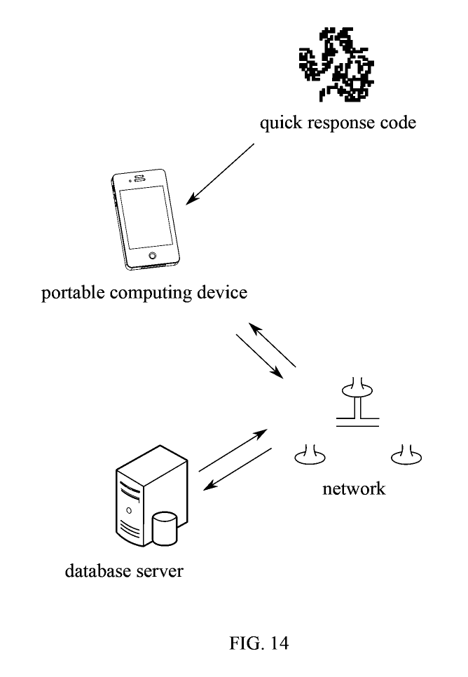

### DETAIL DESCRIPTIONS OF THE INVENTION

All illustrations of the drawings are for the purpose of describing selected versions of the present invention and are not intended to limit the scope of the present invention.

The present invention is a system and method for creating and distributing electronic advertisements. The present invention includes at least one server, or similar device, on which data is stored and through which information is routed to electronic consumer devices. A host website is provided through the at least one server that allows a company to create a user account. Through the user account, the company is able to create and manage advertisements using advertisement creation tools and track advertisement viewership data using advertisement reporting tools. Once an advertisement is created or uploaded, it is instantly made viewable to consumers via the service provider database. Likewise, if the company removes an advertisement from the user account of the company, then the advertisement is instantly removed from the service provider database and will no longer be viewable to consumers.

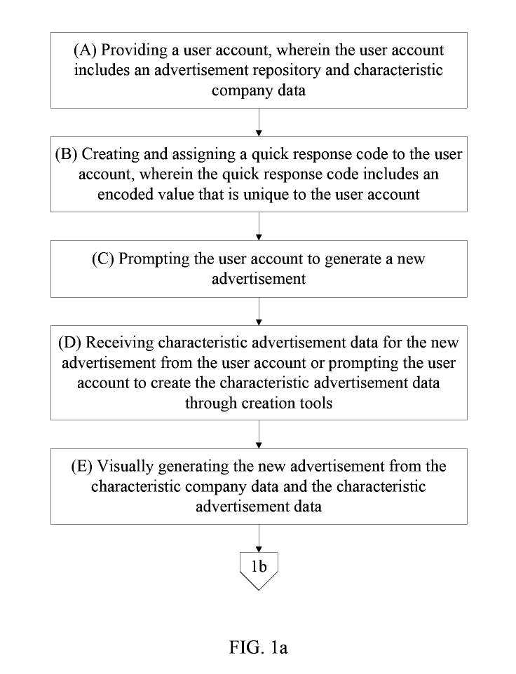

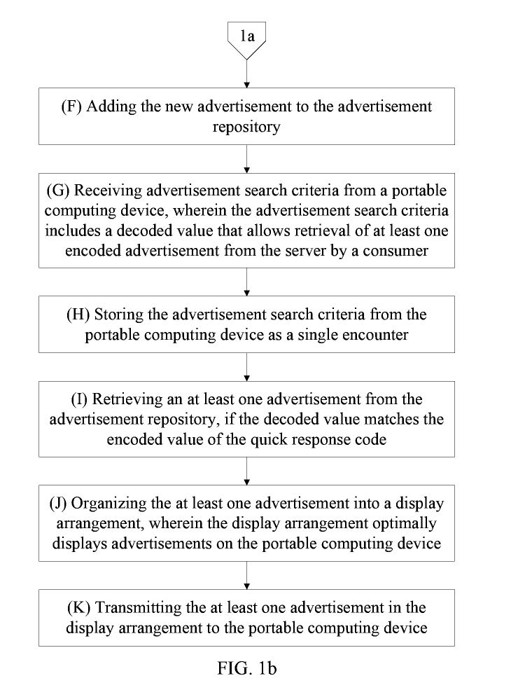

In reference to FIG. 1, the following provides an overview of the included method. A company creates a user account through which the company can create and organize advertisements. A quick response code having an encoded value is created and assigned to the user account and is used to retrieve an at least one advertisement from an advertisement repository of the user account. When a consumer scans the quick response code using a portable computing device, the portable computing device sends advertisement search criteria, which includes a decoded value, to the at least one server. The decoded value is then matched to the encoded value in order to retrieve the at least one advertisement from the advertisement repository of the user account. The at least one advertisement is then organized into a display arrangement according to priority criteria. Once the at least one advertisement has been arranged in the display arrangement, the at least one server transmits the at least one advertisement in the display arrangement to the portable computing device. The at least one advertisement can then be viewed by consumers on the portable computing device. The at least one server can communicate with the portable computing device using any existing network technologies and may include the use of access points such as routers or proxy servers.

The at least one server may include any type of server or combination of servers. In addition to supporting the host website, the at least one server hosts a service provider database in which the user account of each registered company is stored. The user account of each company includes characteristic company data and an advertisement repository. The characteristic company data is supplied by the company and is submitted through input fields provided by the user account. The characteristic company data consists of general company information, such as the company name, company logo, company slogan/message, store locations, and company contact information (e.g. the company website, phone number). The advertisement repository is a collection of actively accessible advertisements that have been created or uploaded to the user account by the company. When an advertisement is removed from the advertisement repository, the advertisement is no longer viewable by consumers.

The host website provides companies with access to the service provider database on a subscription basis. In order to subscribe to the host website and the service provider database, the company must create a user account. In the preferred embodiment of the present invention a fee is required in order to setup the user account. Payments are processed by the at least one server through the host website and may be a flat one time rate or may be required on a monthly basis, yearly basis, per advertisement created/uploaded or using any other subscription format. Once the company has subscribed to the host website by creating the user account and making all required payments, the company is permitted access to all functions of the host website, such as utilizing advertisement creation tools, advertisement reporting tools, etc. Consumers do not need to create an account and can view advertisements free of charge.

Once the company has completed the subscription process by supplying the required personal information, the at least one server creates and assigns a quick response code to the user account of the company. The quick response code generated for each user account is unique and includes an encoded value. The encoded value is used to locate and access the user account that is linked to the quick response code from within the service provider database. In this way, the encoded value is also used to retrieve the collection of advertisements that is being actively managed in the advertisement repository. The quick response code may be provided by the at least one server to the owner of the user account in any format, such as code in a common programming language or as a downloadable file (e.g. a portable document format (PDF) file, a graphics interchange format (GIF) file, a Joint Photographic Experts Group (JPEG) format file).

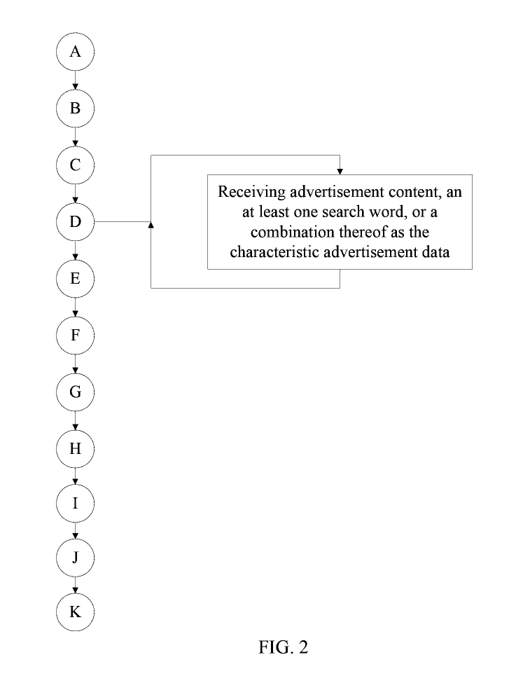

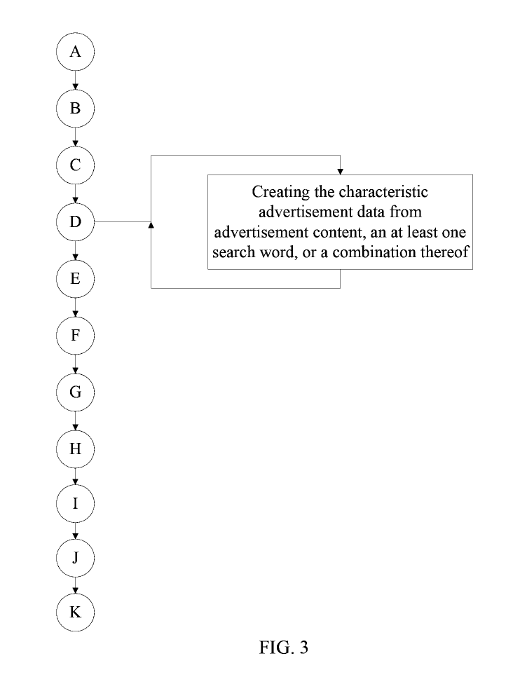

In reference to FIG. 2-3, after the quick response code has been provided for the user account, the at least one server prompts the user account to generate a new advertisement. The owner of the user account can choose to create the new advertisement in one of two ways. The owner can create the new advertisement using advertisement creation tools provided by the at least one server through the host website, or the owner may choose to upload the new advertisement to the at least one server having been already created. If the owner has already created the new advertisement, then the at least one server receives characteristic advertisement data when the new advertisement is uploaded. If the owner of the user account elects to create the new advertisement using the advertisement creation tools, then the at least one server prompts the user account to create the characteristic advertisement data. The characteristic advertisement data includes advertisement content, at least one search word, and any other pertinent advertisement information. The advertisement content includes text, images, embedded media files, embedded webpage links, etc. and dictates the overall appearance of the new advertisement. The at least one search word is determined by the owner and should be a word or combination of words having relevancy to the advertisement content. Consumers can browse for advertisements on the host website using their own search words. Search words matching the at least one search word will in turn cause the related advertisement to be displayed on the host website.

The advertisement creation tools are designed to spur the creativity of the owner of the user account and allow the owner to quickly create custom advertisement designs. One of the advertisement creation tools allows the owner of the user account to choose from a series of preformatted advertisement backgrounds. Alternatively, personal artwork can be uploaded to use as a background or to otherwise be used within the advertisement. Another one of the advertisement creation tools allows the owner of the user account to select from a series of preformatted advertisement templates. The preformatted advertisement templates provides the owner with input fields for inserting the characteristic advertisement data, such as the advertisement content, the at least one search word, a time period to be displayed, an expiration date, or a category designation. Yet another one of the advertisement creation tools allows the owner of the user account to change the text font, color, size, etc. in which the advertisement content is displayed. Through the use of the advertisement creation tools the owner of the user account can readily create customized advertisements in a minimal amount of time. It is also possible for any number of other advertisement creation tools to be utilized to enhance the user experience in addition to those described above.

Once the owner of the user account has supplied the characteristic advertisement data using either method, the at least one server graphically generates the new advertisement from the characteristic advertisement data. The new advertisement is then added to the advertisement repository of the user account. Similarly, any subsequent advertisements that are created or uploaded are added to the advertisement repository. Subsequent advertisements can be created or uploaded at any time from an advertisement details page of the host website.

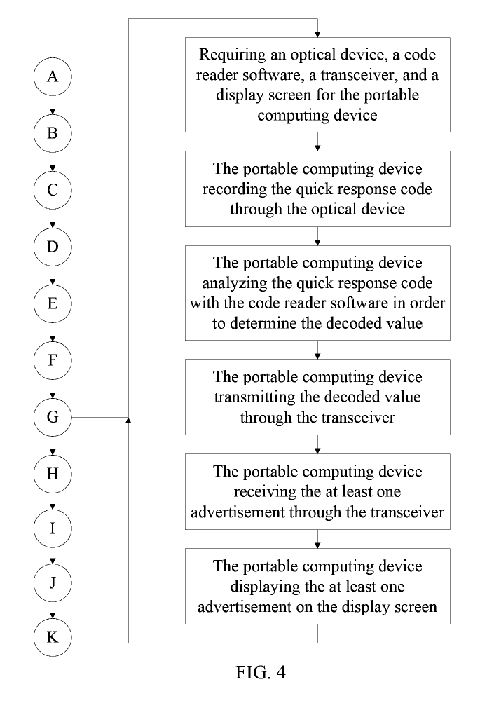

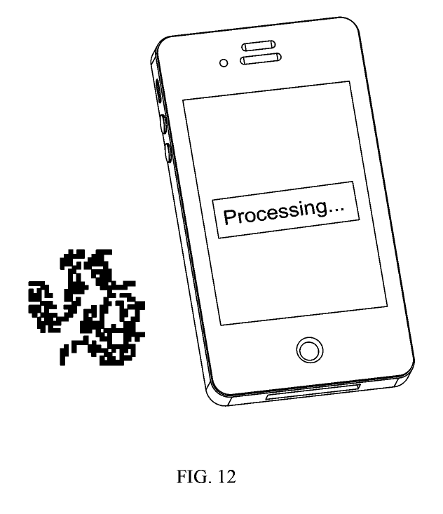

In reference to FIG. 4, when at least one advertisement has been added to the advertisement repository, the owner of the user account may distribute the quick response code linked to the user account. Once the quick response code has been distributed, consumers can utilize a portable computing device to scan the quick response code and access the advertisement repository of the user account linked to the quick response code. The portable computing device can be any electronic device having an optical device, a code reader software, a transceiver, and a display screen. The portable computing device scans and records the quick response code through the optical device. As depicted in FIG. 12, once the optical device has scanned and recorded the quick response code, the portable computing device analyzes the quick response code with the code reader software. The code reader software analyzes the quick response code in order to determine a decoded value. After determining the decoded value, the portable computing device transmits advertisement search criteria that includes the decoded value to the at least one server through the transceiver.

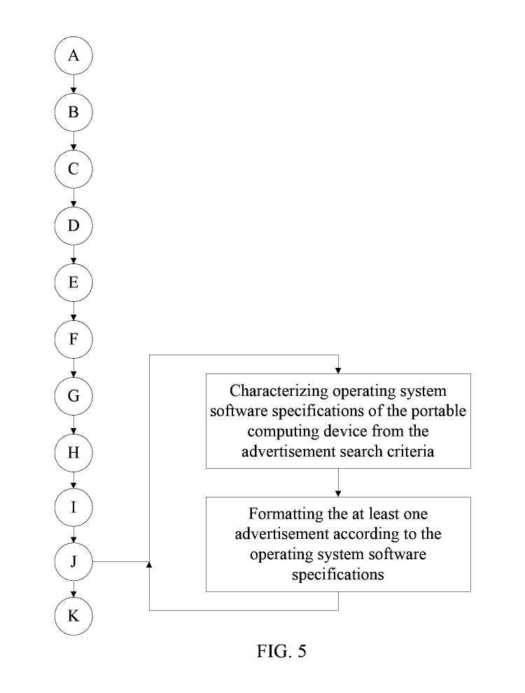

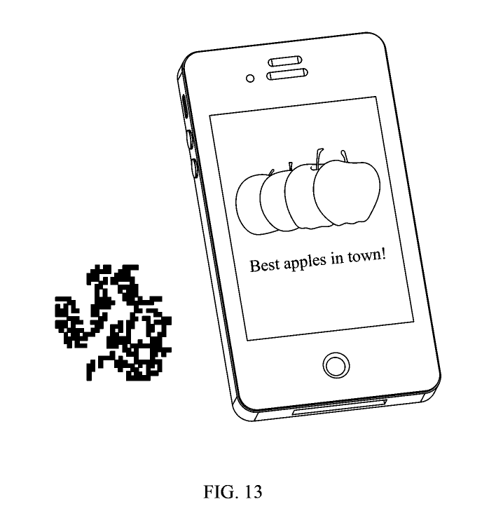

When the at least one server receives the advertisement search criteria transmitted from the portable computing device, the at least one server stores the advertisement search criteria as a single encounter. The at least one server then uses the decoded value to search through the service provider database in order to access the user account linked to the quick response code. When the at least one server finds the encoded value in the service provider database that matches the decoded value received from the portable computing device, the at least one server retrieves the at least one advertisement from the advertisement repository. In reference to FIG. 5, from the advertisement search criteria, the at least one server characterizes operating system software specifications of the portable computing device. The at least one advertisement is then formatted according to the operating system software specifications, such that the at least one advertisement will be optimally displayed on the portable computing device. The at least one advertisement is then organized into a display arrangement by the at least one server. As depicted in FIG. 13, the at least one advertisement is then transmitted to the portable computing device in the display arrangement, wherein the portable computing device receives the at least one advertisement through the transceiver. The at least one advertisement is then displayed on the display screen of the portable computing device, such that the consumer can then view the at least one advertisement organized in the display arrangement.

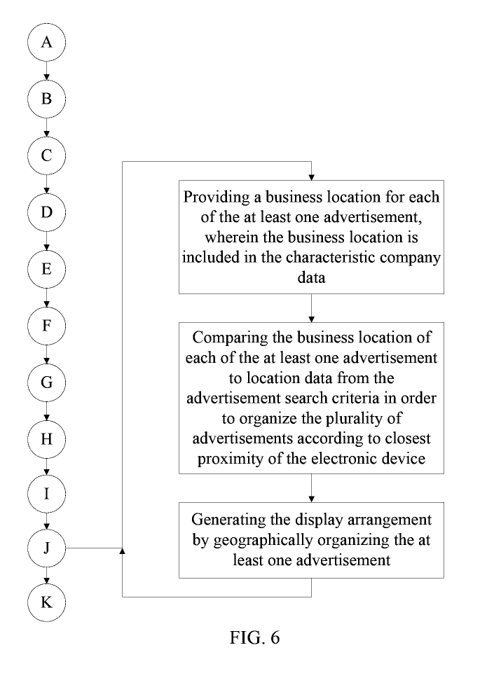

The display arrangement for the at least one advertisement can be determined in a number of different ways using information from the advertisement search criteria or the characteristic advertisement data. In reference to FIG. 6, one way in which the display arrangement can be created is according to the current location of the consumer when the quick response code is scanned and transmitted to the at least one server. Each of the at least one advertisement in the advertisement repository is provided with a business location. The business location is included in the characteristic company data and may be different for each of the at least one advertisement if the company has multiple locations. When the advertisement search criteria is transmitted to the at least one server, the advertisement search criteria includes location data in addition to the decoded value and the operating system software specifications. The location data details the current coordinates from which the consumer has used the portable computing device. The location data from the advertisement search criteria is compared to the business location of each of the at least one advertisement in order to organize the at least one advertisement according to closest proximity of the portable computing device. Once the business location of each of the at least one advertisement has been compared to the location data, the display arrangement is generated by geographically organizing the at least one advertisement in order of closest proximity to the portable computing device. In this way, the consumer is provided with the most relevant advertisements for their current location. For example, a business has multiple state-wide locations and thus may have different advertisements for stores in different regions. When a consumer scans the quick response code associated with the business's user account, advertisements for the store closest to the consumer's current location will be displayed first, followed by advertisements for the next closest location and so on. It is possible for the business location of an advertisement to be designated as online, if the company does not have a physical store in which consumers may visit. Advertisements having the business location being designated as online may be organized before or after advertisements having the business location being a physical location.

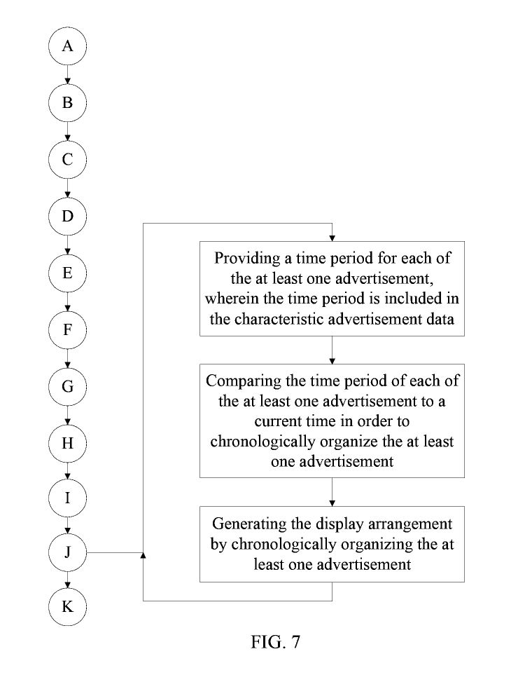

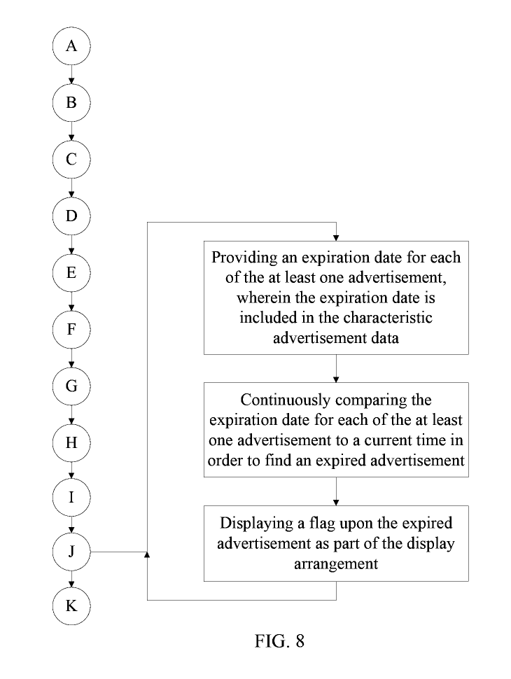

In reference to FIG. 7, another way in which the display arrangement can be created is according to the time and date. Each of the at least one advertisement in the advertisement repository is provided with a time period having a start date and an expiration date. The time period is included in the characteristic advertisement data and as such may be different for each of the at least one advertisement. The time period may be particular hours in a day, days in a week, weeks in a month, etc. When the at least one advertisement is retrieved from the advertisement repository, the time period of each of the at least one advertisement is compared to a current time in order to chronologically organize the at least one advertisement. The current time is constantly updated by the at least one server and includes information such as the current day, month, year, minute, hour, etc. Once the time period of each of the at least one advertisement has been compared to the current time, the display arrangement is generated by chronologically organizing the at least one advertisement. In this way, the consumer is provided with the most relevant advertisements for the particular date and time at which they scanned the quick response code. For example, advertisements for which the start date and the expiration date encompass the current time will be displayed before advertisements for which the current time resides outside of the start date and the expiration date. As another example, the start time and the end time may be particular hours of the day for each day of the week. In this way, a restaurant may have advertisements for both lunch specials and dinner specials. The restaurant may then choose to have advertisements featuring lunch specials displayed to the consumer before dinner specials in the late morning and afternoon, while having dinner specials displayed before lunch specials in the evening. In reference to FIG. 8, the at least one server also continuously compares the expiration date of each of the at least one advertisement to the current time in order to find an expired advertisement. If the current time has exceeded the expiration date, then the advertisement is marked as the expired advertisement. While the display arrangement is being created, a flag is displayed upon the expired advertisement as part of the display arrangement. In this way, if the advertisement features a deal or sale, then consumers are notified that said deal or sale is no longer applicable.

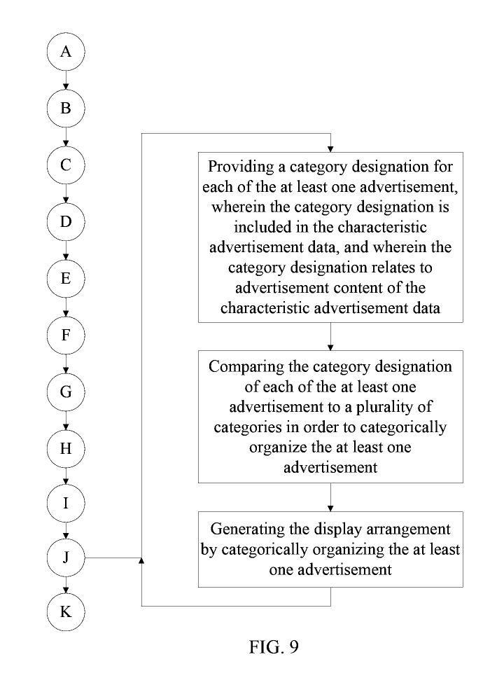

In reference to FIG. 9, yet another way in which the display arrangement can be created is according to category. Each of the at least one advertisement in the advertisement repository is provided with a category designation. The category designation is included in the characteristic advertisement data and as such may be different for each of the at least one advertisement. The category designation relates to the advertisement content and is selected from a plurality of categories that are defined by the owner of the user account. The plurality of categories may also be determined and provided by the host website. When the at least one advertisement is retrieved from the advertisement repository, the category designation of each of the at least one advertisement is compared to the plurality of categories in order to categorically organize the at least one advertisement. The display arrangement is then generated by categorically organizing the at least one advertisement according to the plurality of categories as defined by the owner of the user account. For example, the plurality of categories for a clothing store may include men's clothing, women's clothing, and children's clothing. Advertisements for which the category designation is men's clothing will be grouped together, advertisements for which the category designation is women's clothing will be grouped together, and advertisements for which the category designation is children's clothing will be grouped together. In addition to the methods described above, it is also possible for the display arrangement to be generated using any other type of priority criteria.

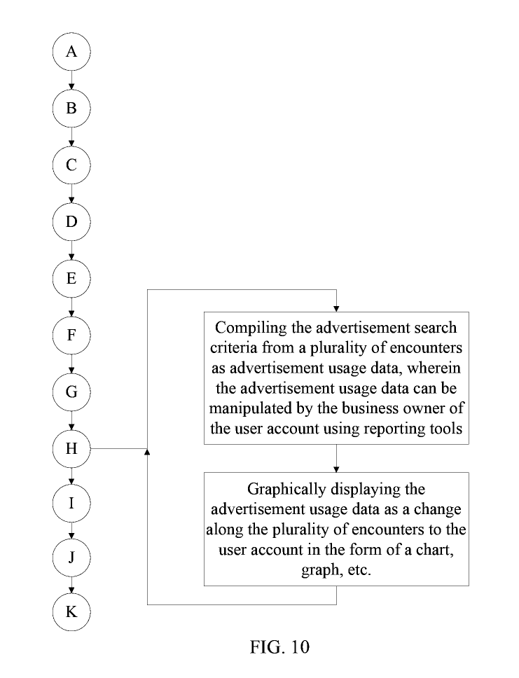

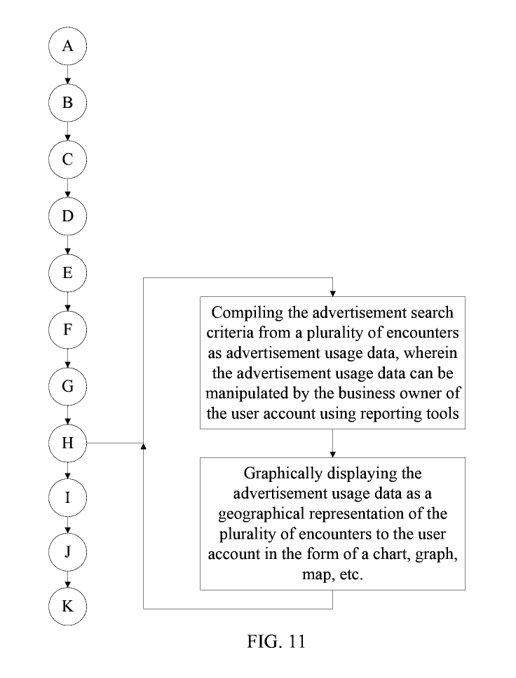

In reference to FIG. 10-11, each time the quick response code is scanned, the advertisement search criteria is saved as a single encounter in the service provider database. The at least one server compiles the advertisement search criteria from a plurality of encounters as advertisement viewership data; thus the advertisement viewership data contains the decoded value, location data, operating system software specifications, and any other relevant advertisement usage information from each instance in which the at least one advertisement is retrieved from the advertisement repository. The advertisement viewership data is then made available to the company through the user account. Using reporting tools provided by the host website, the owner of the user account can manipulate the way in which the advertisement viewership data is displayed. When a reporting tool is selected, the at least one server graphically displays the advertisement viewership data as a change along the plurality of encounters, to the user account (i.e. a change in advertisement viewership data over time) in the form of charts, graphs, etc. One such reporting tool allows the owner of the user account to track how many times the quick response code has been scanned over a period of time. In this way, the owner can view how many times each of the at least one advertisement is accessed each day, month, year, etc. Another reporting tool allows the subscribed user to view the advertisement viewership data based on location. The at least one server graphically displays the advertisement viewership data as a geographical representation of the plurality of encounters to the user account using the location data. This information can be used to determine regions where other forms of advertising may be needed, regions where additional advertising is not needed, etc. It is the function of other reporting tools to track the advertisement viewing habits of consumers, such as the most viewed advertisements, most viewed categories, most used search words, the most common type of operating system from which advertisements are accessed, etc. Companies can utilize this information to more efficiently organize the order in which advertisements are displayed to the consumer. It is also possible for any number of other reporting tools to be utilized in addition to those described above.

Although the invention has been explained in relation to its preferred embodiment, it is to be understood that many other possible modifications and variations can be made without departing from the spirit and scope of the invention as hereinafter claimed.

What is claimed is:

1. A method for creating and distributing electronic advertisements by executing computer-executable instructions stored on a non-transitory computer-readable medium, the method comprises the steps of:
(A) providing a user account, wherein the user account includes an advertisement repository and characteristic company data;
(B) creating and assigning a quick response code to the user account, wherein the quick response code includes an encoded value;
(C) prompting the user account to generate a new advertisement;
(D) receiving characteristic advertisement data for the new advertisement from the user account or prompting the user account to create the characteristic advertisement data through advertisement creation tools;
(E) graphically generating the new advertisement from the characteristic advertisement data;
(F) adding the new advertisement to the advertisement repository;
(G) receiving advertisement search criteria from a portable computing device, wherein the advertisement search criteria includes a decoded value;
(H) storing the advertisement search criteria from the portable computing device as a single encounter;
(I) retrieving an at least one advertisement from the advertisement repository, if the decoded value matches the encoded value of the quick response code;
(J) organizing the at least one advertisement into a display arrangement, wherein the display arrangement optimally displays advertisements on the portable computing device; and
(K) transmitting the at least one advertisement in the display arrangement to the portable computing device.

2. The method for creating and distributing electronic advertisements by executing computer-executable instructions stored on a non-transitory computer-readable medium, the method as claimed in claim 1 further comprises the steps of:
compiling the advertisement search criteria from a plurality of encounters as advertisement viewership data; and
graphically displaying the advertisement viewership data as a change along the plurality of encounters to the user account.

3. The method for creating and distributing electronic advertisements by executing computer-executable instructions stored on a non-transitory computer-readable medium, the method as claimed in claim 1 further comprises the steps of:
compiling the advertisement search criteria from a plurality of encounters as advertisement viewership data; and
graphically displaying the advertisement viewership data as a geographical representation of the plurality of encounters to the user account.

4. The method for creating and distributing electronic advertisements by executing computer-executable instructions stored on a non-transitory computer-readable medium, the method as claimed in claim 1 further comprises the steps of:
characterizing operating system software specifications of the portable computing device from the advertisement search criteria; and
formatting the at least one advertisement according to the operating system software specifications.

5. The method for creating and distributing electronic advertisements by executing computer-executable instructions stored on a non-transitory computer-readable medium, the method as claimed in claim 1 further comprises the steps of:
receiving advertisement content, an at least one search word, or a combination thereof as the characteristic advertisement data.

6. The method for creating and distributing electronic advertisements by executing computer-executable instructions stored on a non-transitory computer-readable medium, the method as claimed in claim 1 further comprises the steps of:
creating the characteristic advertisement data from advertisement content, an at least one search word, or a combination thereof.

7. The method for creating and distributing electronic advertisements by executing computer-executable instructions stored on a non-transitory computer-readable medium, the method as claimed in claim 1, wherein:
providing an optical device, a code reader software, a transceiver, and a display screen for the portable computing device;
the portable computing device recording the quick response code through the optical device;
the portable computing device analyzing the quick response code with the code reader software in order to determine the decoded value;
the portable computing device transmitting the decoded value through the transceiver;
the portable computing device receiving the at least one advertisement through the transceiver; and
the portable computing device displaying the at least one advertisement on the display screen.

8. The method for creating and distributing electronic advertisements by executing computer-executable instructions stored on a non-transitory computer-readable medium, the method as claimed in claim 1 further comprises the steps of:
providing an expiration date for each of the at least one advertisement, wherein the expiration date is included in the characteristic advertisement data;
continuously comparing the expiration date for each of the at least one advertisement to a current time in order to find an expired advertisement; and
displaying a flag upon the expired advertisement as part of the display arrangement.

9. The method for creating and distributing electronic advertisements by executing computer-executable instructions stored on a non-transitory computer-readable medium, the method as claimed in claim 1 further comprises the steps of:
providing a business location for each of the at least one advertisement, wherein the business location is included in the characteristic company data;
comparing the business location of each of the at least one advertisement to location data from the advertisement search criteria in order to organize the at least one advertisement according to closest proximity of the electronic device; and
generating the display arrangement by geographically organizing the at least one advertisement.

10. The method for creating and distributing electronic advertisements by executing computer-executable instructions stored on a non-transitory computer-readable medium, the method as claimed in claim 1 further comprises the steps of:
providing a time period for each of the at least one advertisement, wherein the time period is included in the characteristic advertisement data;
comparing the time period of each of the at least one advertisement to a current time in order to chronologically organize the at least one advertisement; and
generating the display arrangement by chronologically organizing the at least one advertisement.

11. The method for creating and distributing electronic advertisements by executing computer-executable instructions stored on a non-transitory computer-readable medium, the method as claimed in claim 1 further comprises the steps of:
providing a category designation for each of the at least one advertisement, wherein the category designation is included in the characteristic advertisement data, and wherein the category designation relates to advertisement content of the characteristic advertisement data;
comparing the category designation of each of the at least one advertisement to a plurality of categories in order to categorically organize the at least one advertisement; and
generating the display arrangement by categorically organizing the at least one advertisement.

12. A method for creating and distributing electronic advertisements by executing computer-executable instructions stored on a non-transitory computer-readable medium, the method comprises the steps of:
(A) providing a user account, wherein the user account includes an advertisement repository and characteristic company data;
(B) creating and assigning a quick response code to the user account, wherein the quick response code includes an encoded value;
(C) prompting the user account to generate a new advertisement;
(D) receiving characteristic advertisement data for the new advertisement from the user account or prompting the user account to create the characteristic advertisement data through advertisement creation tools;
(E) graphically generating the new advertisement from the characteristic advertisement data;
(F) adding the new advertisement to the advertisement repository;
(G) receiving advertisement search criteria from a portable computing device, wherein the advertisement search criteria includes a decoded value;
(H) storing the advertisement search criteria from the portable computing device as a single encounter;
(I) compiling the advertisement search criteria from a plurality of encounters as advertisement viewership data;
(J) retrieving an at least one advertisement from the advertisement repository, if the decoded value matches the encoded value of the quick response code;
(K) characterizing operating system software specifications of the portable computing device from the advertisement search criteria;
(L) formatting the at least one advertisement according to the operating system software specifications;
(M) organizing the at least one advertisement into a display arrangement, wherein the display arrangement optimally displays advertisements on the portable computing device; and
(N) transmitting the at least one advertisement in the display arrangement to the portable computing device.

13. The method for creating and distributing electronic advertisements by executing computer-executable instructions stored on a non-transitory computer-readable medium, the method as claimed in claim 12 further comprises the steps of:
graphically displaying the advertisement viewership data as a change along the plurality of encounters and as a geographical representation of the plurality of encounters to the user account.

14. The method for creating and distributing electronic advertisements by executing computer-executable instructions stored on a non-transitory computer-readable medium, the method as claimed in claim 12 further comprises the steps of:
receiving advertisement content, an at least one search word, or a combination thereof as the characteristic advertisement data.

15. The method for creating and distributing electronic advertisements by executing computer-executable instructions stored on a non-transitory computer-readable medium, the method as claimed in claim 12 further comprises the steps of:
creating the characteristic advertisement data from advertisement content, an at least one search word, or a combination thereof.

16. The method for creating and distributing electronic advertisements by executing computer-executable instructions stored on a non-transitory computer-readable medium, the method as claimed in claim 12, wherein:
providing an optical device, a code reader software, a transceiver, and a display screen for the portable computing device;
the portable computing device recording the quick response code through the optical device;
the portable computing device analyzing the quick response code with the code reader software in order to determine the decoded value;
the portable computing device transmitting the decoded value through the transceiver;
the portable computing device receiving the at least one advertisement through the transceiver; and
the portable computing device displaying the at least one advertisement on the display screen.

17. The method for creating and distributing electronic advertisements by executing computer-executable instructions stored on a non-transitory computer-readable medium, the method as claimed in claim 12 further comprises the steps of:
providing an expiration date for each of the at least one advertisement, wherein the expiration date is included in the characteristic advertisement data;
continuously comparing the expiration date for each of the at least one advertisement to a current time in order to find an expired advertisement; and
displaying a flag upon the expired advertisement as part of the display arrangement.

18. The method for creating and distributing electronic advertisements by executing computer-executable instructions stored on a non-transitory computer-readable medium, the method as claimed in claim 12 further comprises the steps of:
providing a business location for each of the at least one advertisement, wherein the business location is included in the characteristic company data;
comparing the business location of each of the at least one advertisement to location data from the advertisement search criteria in order to organize the at least one advertisement according to closest proximity of the electronic device; and
generating the display arrangement by geographically organizing the at least one advertisement.

19. The method for creating and distributing electronic advertisements by executing computer-executable instructions stored on a non-transitory computer-readable medium, the method as claimed in claim 12 further comprises the steps of:
providing a time period for each of the at least one advertisement, wherein the time period is included in the characteristic advertisement data;
comparing the time period of each of the at least one advertisement to a current time in order to chronologically organize the at least one advertisement; and
generating the display arrangement by chronologically organizing the at least one advertisement.

20. The method for creating and distributing electronic advertisements by executing computer-executable instructions stored on a non-transitory computer-readable medium, the method as claimed in claim 12 further comprises the steps of:
providing a category designation for each of the at least one advertisement, wherein the category designation is included in the characteristic advertisement data, and wherein the category designation relates to advertisement content of the characteristic advertisement data;
comparing the category designation of each of the at least one advertisement to a plurality of categories in order to categorically organize the at least one advertisement; and
generating the display arrangement by categorically organizing the at least one advertisement.
